(19) United States
(12) Patent Application Publication
(10) Pub. No.: US 2003/0032510 A1
(43) Pub. Date: Feb. 13, 2003

(54) Chainwheel having integrated chain guard

(76) Inventor: Chang-Hui Lin, Chang-Wha (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/923,857

(22) Filed: Aug. 7, 2001

(51) Int. Cl. F16H 55/12; F16H 55/30

(52) U.S. Cl. 474/160

(57) ABSTRACT

A chainwheel assembly includes a chainwheel having a guard member connected to a first side thereof and an annular groove is defined between the chainwheel and the guard member. A diameter of the guard member is larger than a diameter of the chainwheel. An axle integrally extends from a second side of the guard member and a crank integrally connected to the guard member.

### FIELD OF THE INVENTION

The present invention relates to a bicycle chainwheel having a chain guard which is made integrally with the chainwheel.

### BACKGROUND OF THE INVENTION

A conventional bicycle chainwheel is engaged with a chain and the chainwheel is connected to a crank so that the rider may rotate the crank to move the bicycle forward by making the chain drive the front chainwheel and the rear chainwheel. The chainwheel used in a mount bike, it is required to be made thicker than the chainwheel used in the normal bicycles because the chainwheel is more likely to receive impacts during riding. A chain guard is usually connected to the frame of the bicycle so as to cover the chain from being accessed by dust or even the rider's pants legs. However, such conventional chain guard is made from a thin metal or even plastic plate which is weak when being impacted and is easily to be deformed or folded inward. The deformed or folded chain guard could jam or block the movement of the chain and makes the bicycle stop suddenly.

### SUMMARY OF THE INVENTION

In accordance with one aspect of the present invention, there is provided a chainwheel assembly which comprises a chainwheel had a guard member connected to a first side thereof and a diameter of the guard member is larger than a diameter of the chainwheel. An annular groove is defined between the chainwheel and the guard member.

The primary object of the present invention is to provide a chainwheel assembly that has an axle and a guard member integrally connected therewith.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the chainwheel and the guard member are made from a metal rod;

FIG. 2 is a side view to show the chainwheel assembly of the present invention;

FIG. 3 is an end view to show the chainwheel assembly of the present invention;

FIG. 4 is a side view to show another embodiment of the chainwheel assembly with the crank, and

FIG. 5 is a cross sectional view to show the another embodiment of the chainwheel assembly with the crank.

### DETAILED DESCRIPTION OF THE PREFERRED EMBODIMENTS

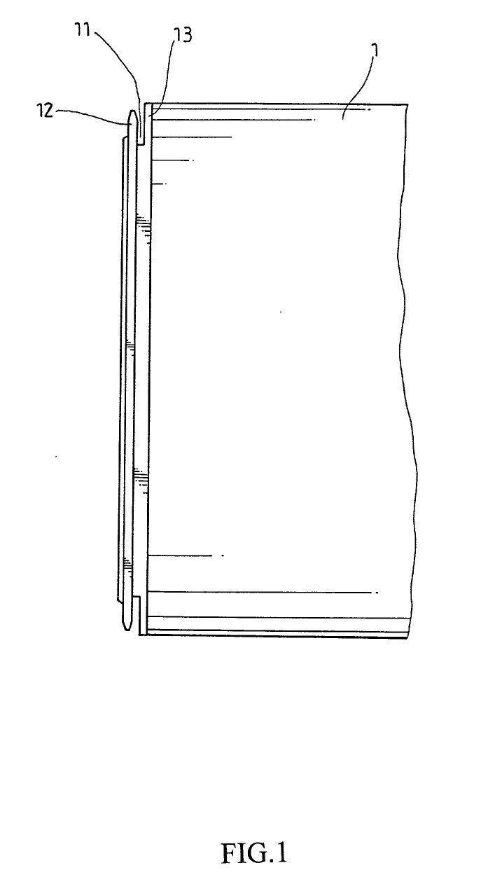

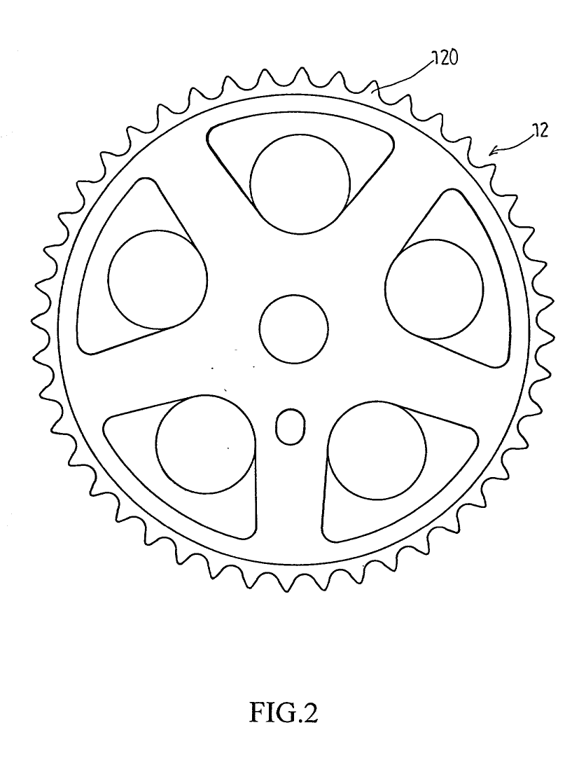

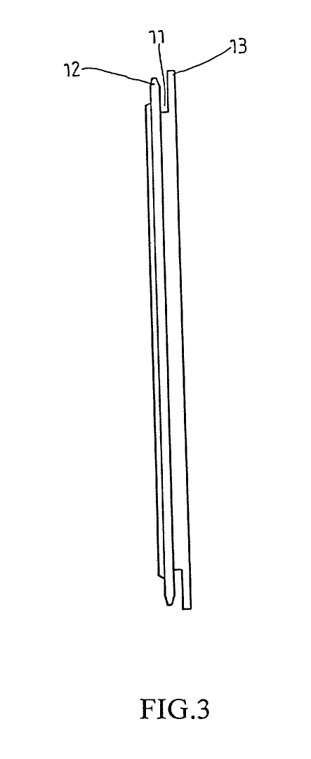

Referring to FIGS. 1 to 3, the chainwheel of the present invention in this embodiment is made from a metal rod 1 or any other proper material by making an annular groove 11 along the outer periphery of the metal rod 1 so as to obtain a chainwheel 12 and a guard member 13 which is to be cut from the metal rod 1. The chainwheel 12 is machined to have teeth 120 on the periphery thereof so as to be engaged with a chain (not shown). The diameter of the chainwheel 12 is smaller than the diameter of the guard member 13 which is located at the first side of the chainwheel 12 so that the teeth 120 of the chainwheel 12 can be protected by the guard member 13.

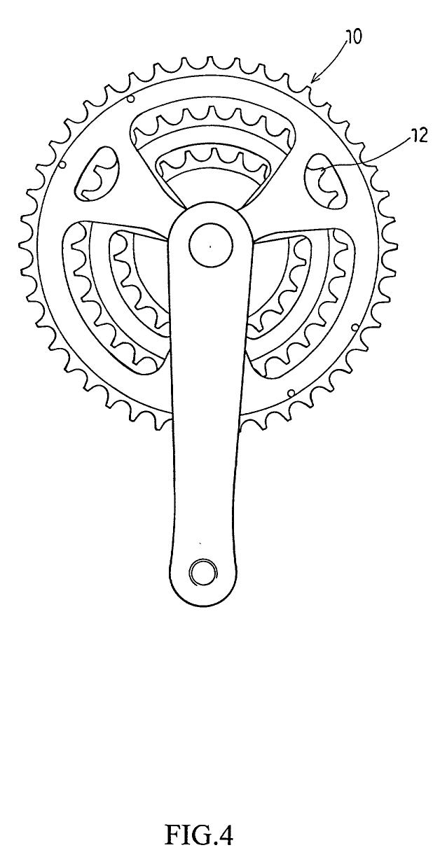

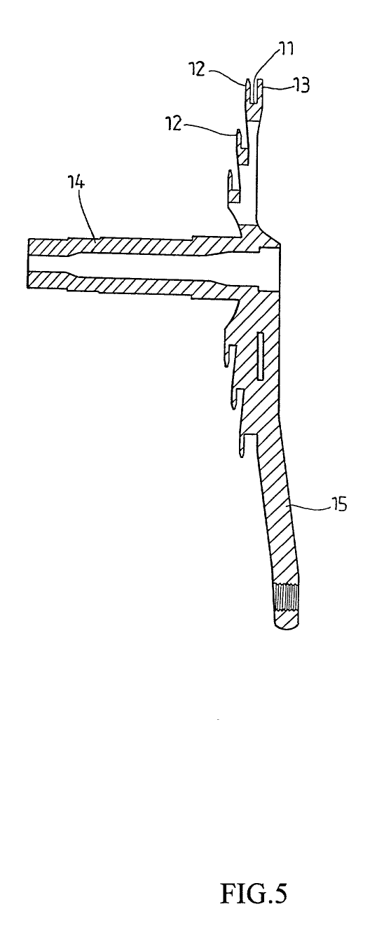

As shown in FIGS. 4 and 5, the number of the chainwheels 12 can be plural and the diameter of these chainwheels 12 are reduced gradually. Grooves are defined between these chainwheels 12. An axle 14 integrally and perpendicularly extends from a second side of the chainwheels 12 and a crank 15 is integrally connected to the guard member 13. It is to be noted that the axle 14, the crank 15, the chainwheels 12 and the guard member 13 are lathed from a solid metal rod 1 so that all the parts are a one-piece member so that it has a better structural strength.

While we have shown and described the embodiments in accordance with the present invention, it should be clear to those skilled in the art that further embodiments may be made without departing from the scope of the present invention.

What is claimed is:

1. A chainwheel assembly comprising:
a chainwheel having a guard member connected to a first side thereof and a diameter of said guard member being larger than a diameter of said chainwheel, an annular groove defined between said chainwheel and said guard member.

2. The chainwheel assembly as claimed in claim 1, wherein said chainwheel has an axle integrally extending from a second side thereof.

3. The chainwheel assembly as claimed in claim 1 further comprising a crank integrally connected to said guard member.
